(19) United States
(12) Patent Application Publication
(10) Pub. No.: US 2013/0243905 A1
(43) Pub. Date: Sep. 19, 2013

(54) MACHINE FOR FOLDING AN EDIBLE DOUGH

(71) Applicants: Franco Fusari, Bagnacavallo (RA) (IT); Michele Bufano, Massa Lombarda (RA) (IT); Alessandro Landi, Bagnacavallo (RA) (IT)

(72) Inventors: Franco Fusari, Bagnacavallo (RA) (IT); Michele Bufano, Massa Lombarda (RA) (IT); Alessandro Landi, Bagnacavallo (RA) (IT)

(73) Assignee: MINIPAN S.R.L., Massa Lombarda (RA) (IT)

(21) Appl. No.: 13/991,224

(22) PCT Filed: Nov. 4, 2011
(86) PCT No.: PCT/EP11/69466

§ 371 Date: Jun. 3, 2013

(30) Foreign Application Priority Data
Dec. 2, 2010 (IT) MI2010A002229

(51) Int. Cl. A21C 1/14; A21D 6/00

(52) U.S. Cl. CPC A21C 1/1405; A21D 6/00
USPC 426/19; 425/200

(57) ABSTRACT

A machine for folding an edible dough is described. The machine includes a hopper for loading and unloading the edible dough, stretching elements and a couple of supporting and folding elements being selectably horizontally movable between opposite lateral resting areas and a central working area of the machine.

The present invention concerns a machine for folding an edible kneading.

It is known that the bread-making process comprises the steps of fermenting/leavening and forming an edible kneading.

The fermenting/leavening step usually lasts about 8 hours and, by stretching the gluten fibres, allows a kneading to be obtained with a specific weight of about 0.4-0.5 kg per litre. The forming usually takes place by means of extrusion which subjects the kneading to a mechanical stress which substantially reduces the effect of the long fermentation, i.e. it twists the gluten fibres, thus creating complex gluten webs which are unfavourable to the development of internal porosities and to the volume increase (leavening) of the kneading: the result is an increase in the specific weight which reaches 0.8-0.9 kg/l. A subsequent step of lamination again reduces the specific weight, reactivating the leavening of the kneading.

It is known that the lower the specific weight, the better the leavening of the kneading, because the development of porosities favours the evaporation of water and the volume increase of the kneading.

The object of the present invention is to provide a machine adapted to form the kneading block, thus limiting the increase in specific weight and therefore favouring the leavening of the kneading.

In accordance with the invention, this object is achieved with a machine for folding an edible kneading, characterized in that it comprises a hopper for loading and unloading the edible kneading, stretching means and a couple of supporting and folding means of the edible kneading, said supporting and folding means being selectably horizontally movable between opposite lateral resting areas and a central working area of the machine.

These and other features of the present invention will become more apparent from the following detailed description of a practical embodiment thereof, shown by way of non-limiting example in the accompanying drawings, in which:

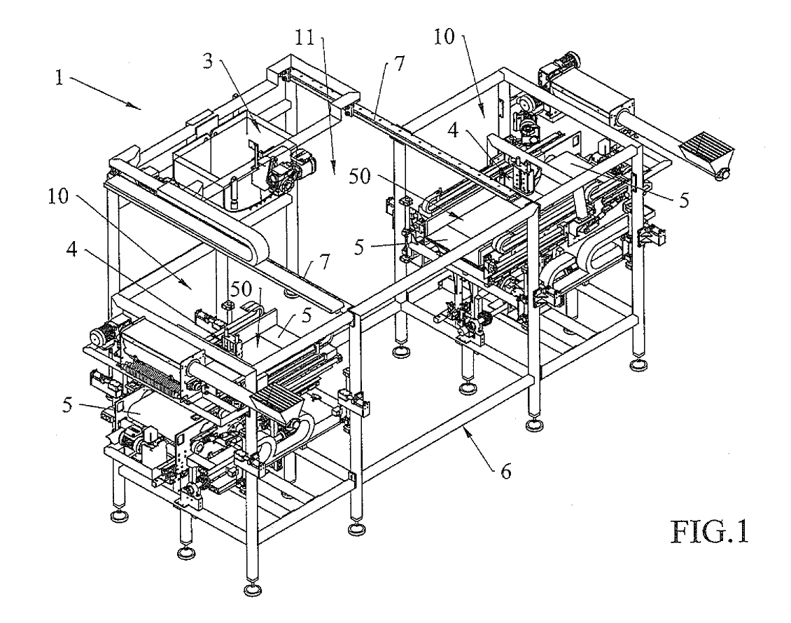

FIG. 1 shows a front perspective view of a machine according to the present invention;

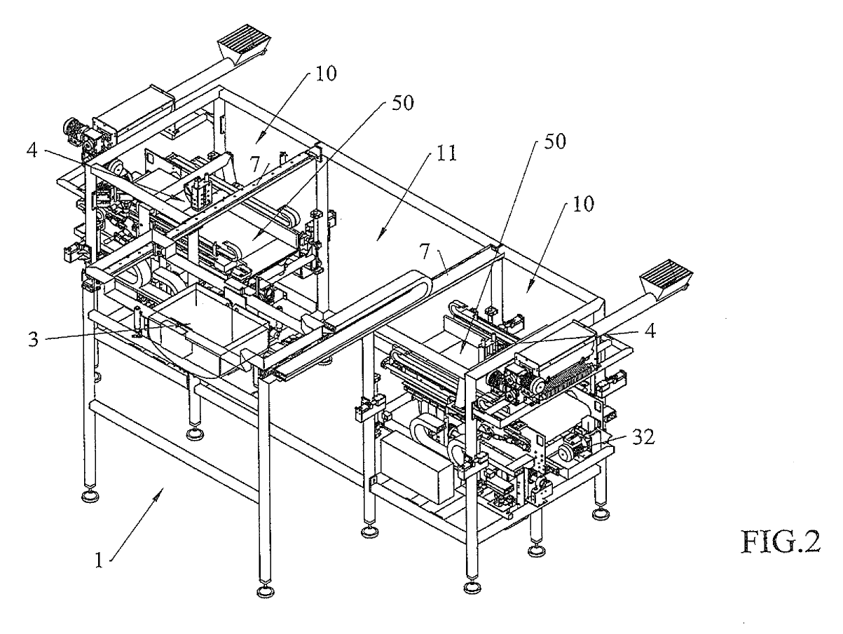

FIG. 2 shows a rear perspective view of the machine;

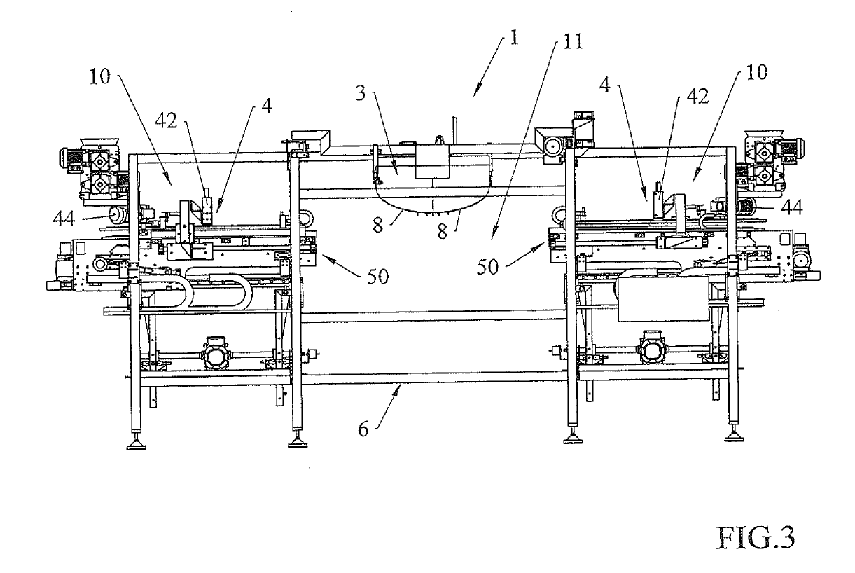

FIG. 3 shows a front view of the machine;

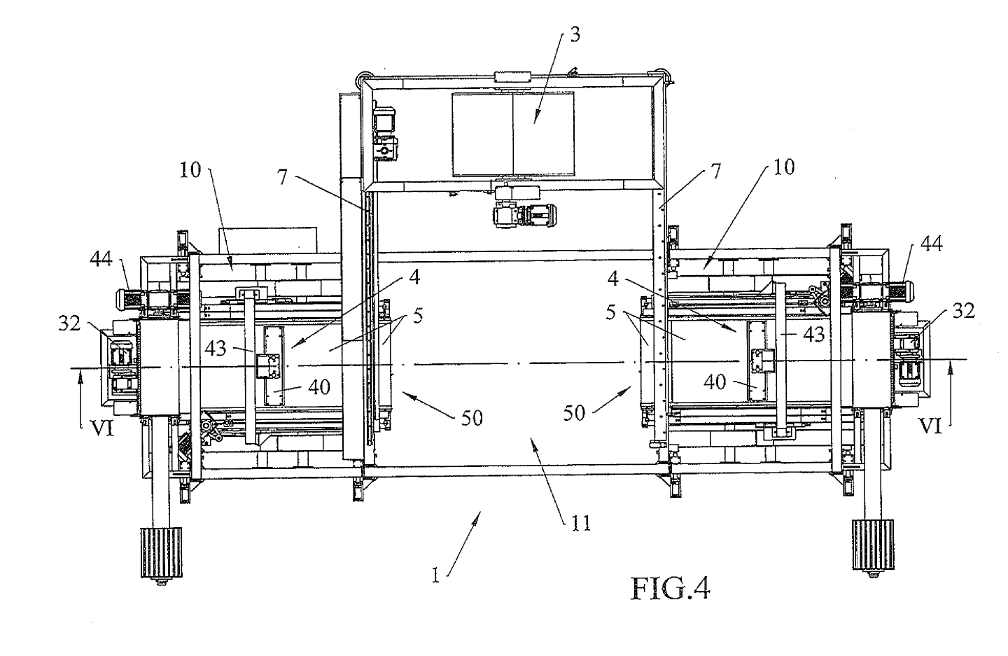

FIG. 4 shows a top plan view of the machine;

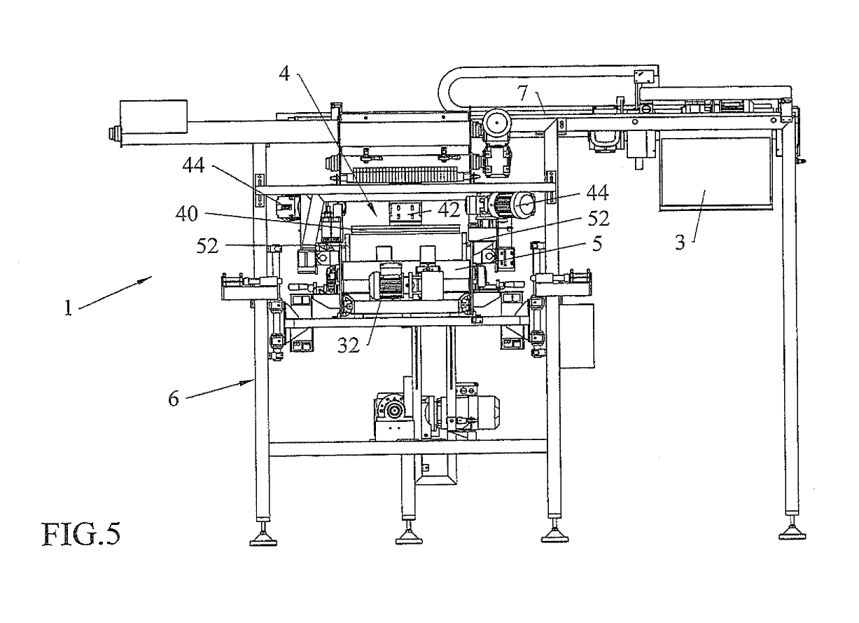

FIG. 5 shows a side view of the machine;

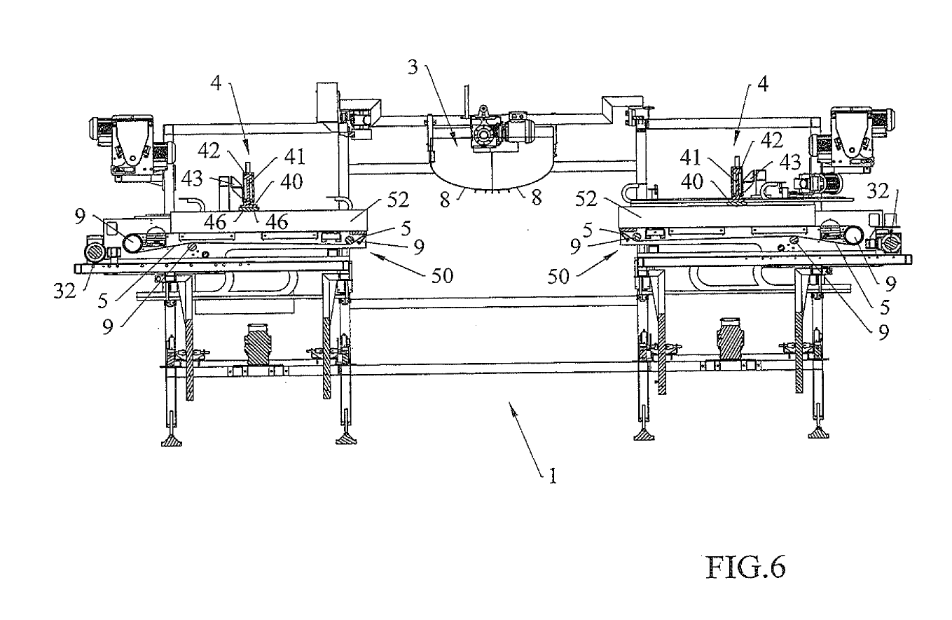

FIG. 6 shows a section view according to the line VI-VI in FIG. 4;

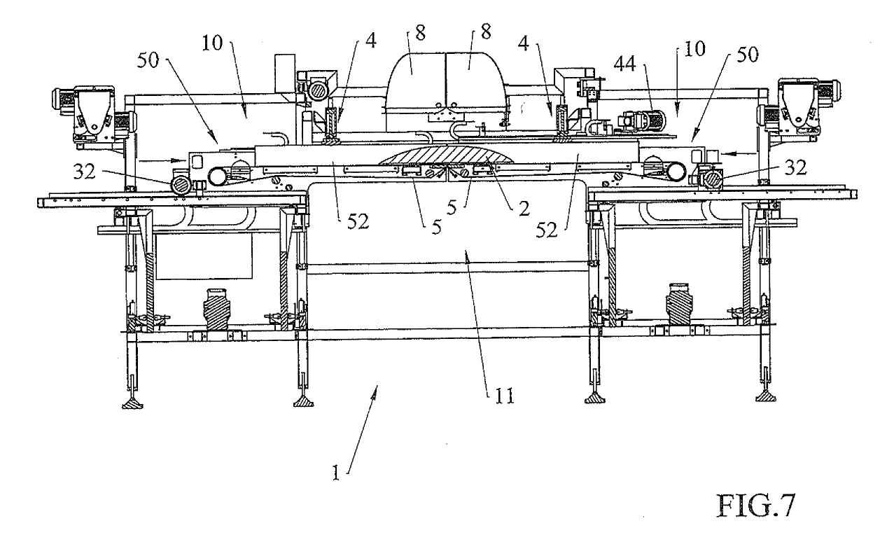

FIG. 7 shows a section view similar to that in FIG. 6, before unloading the edible block from the hopper:

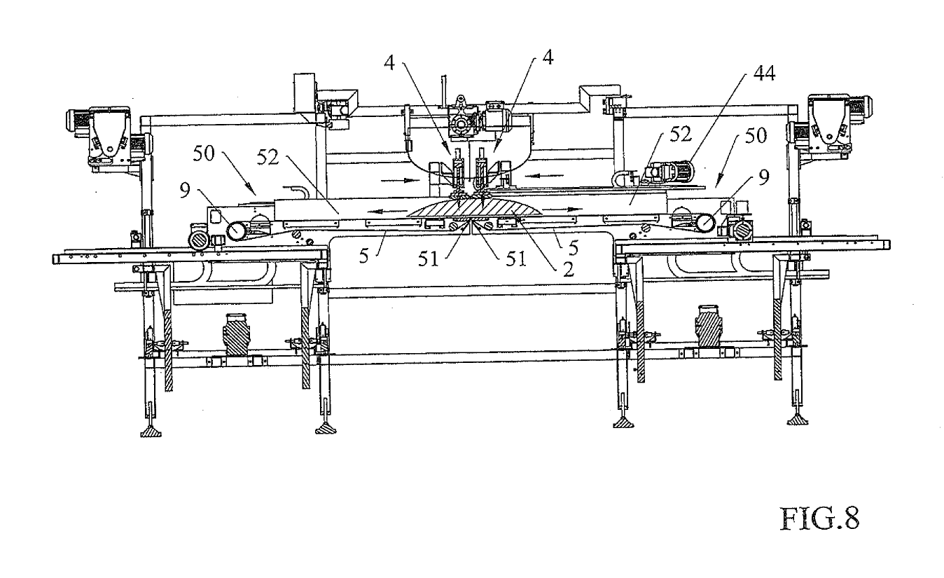

FIG. 8 shows a section view similar to that in FIG. 6, after the unloading of the edible block with the stretching means in a first working position;

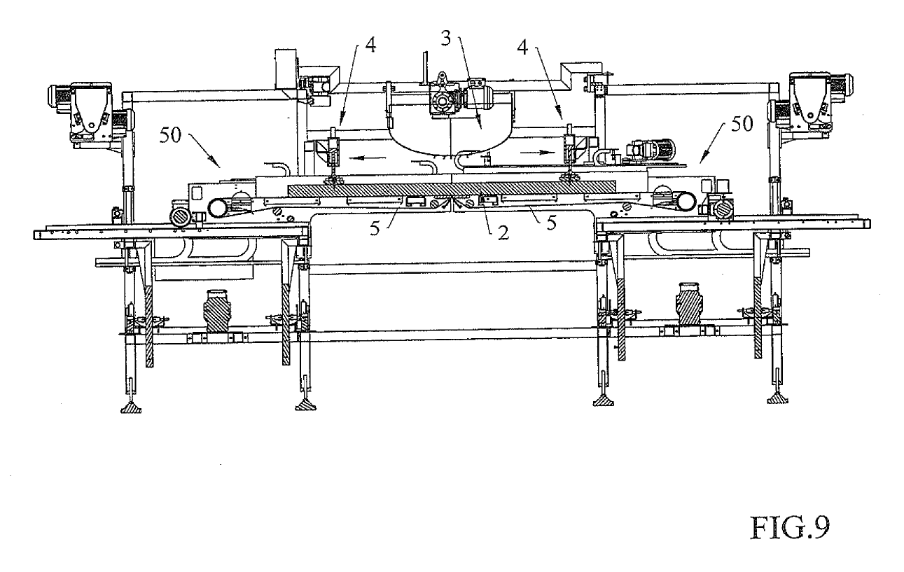

FIG. 9 shows a section view similar to that in FIG. 6, with the stretching means in a second working position;

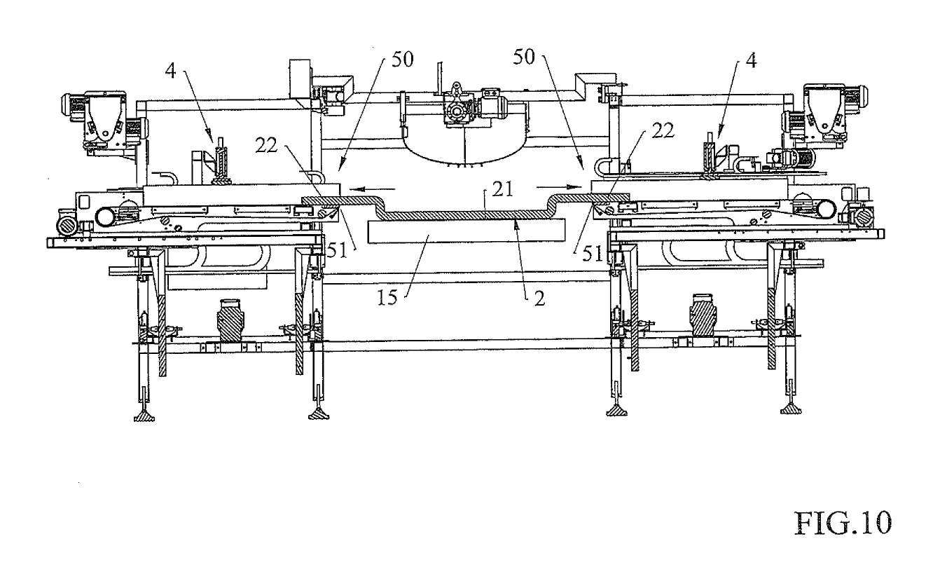

FIG. 10 shows a section view similar to that in FIG. 6, with the machine in an unloading position of the stretched block;

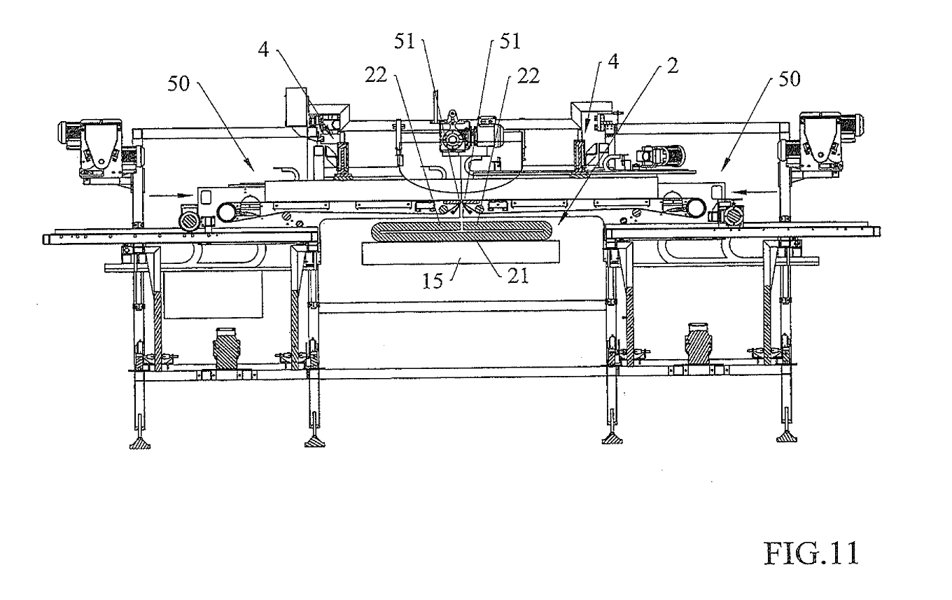

FIG. 11 shows a section view similar to that in FIG. 6, with the belts being folding the stretched block;

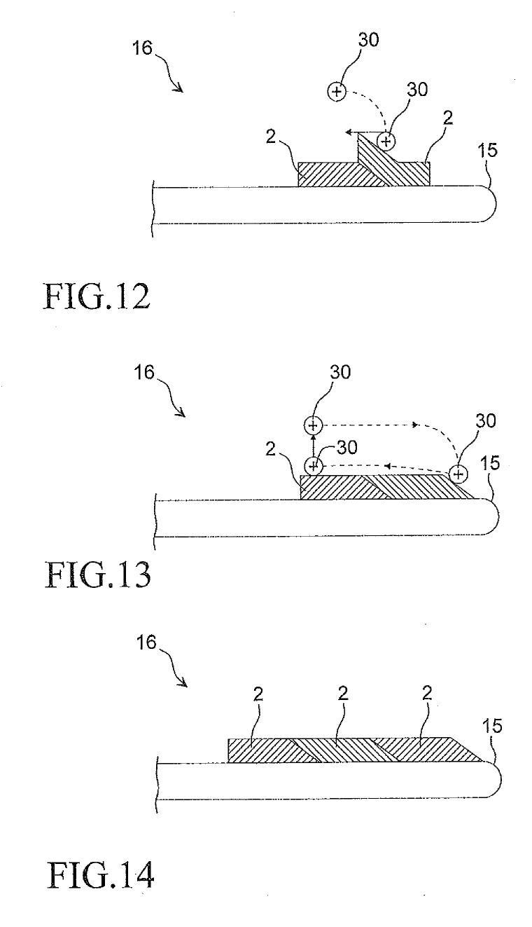

FIG. 12 shows a side view of the conveyor belt of the folded block partially overlapping a previously unloaded folded block;

FIG. 13 shows a side view of the conveyor belt with two blocks joined to form a single ribbon;

FIG. 14 shows a side view of the conveyor belt with three blocks joined to form a single ribbon.

A machine 1 for folding an edible kneading 2 comprises a hopper 3 for loading the fermented kneading 2, two stretching pushers 4 and two supporting and folding assemblies 50 comprising moving belts 5 kept under tension by belt tensioner rollers 9, and containment walls 52 for the edible kneading 2.

Every pusher 4 comprises a contact element 40 with the kneading 2 which lays substantially horizontal being supported by a piston 41 vertically sliding inside a box 42 integral with an arm 43 horizontally movable by means of a driving motor 44. The contact element 40 can thus move vertically and horizontally, and includes a non flat, lower surface, e.g. with two portions 46 inclined downwards which meet at a vertical median plane; said shape of the lower surface allows improved stretching of the kneading 2, thus avoiding sideways contact of the edge of contact element 40 with the kneading 2.

Instead of said pusher 4, a stretching roller with horizontal rotation axis can be provided, being idly mounted on said arm 43.

A supporting frame 6 includes horizontal guides 7 adapted to allow hopper 3 to horizontally translate from a loading position to an unloading position in which swinging portions 8 open in order to allow the fermented kneading 2 to fall onto the supporting belts 5.

Said supporting and folding means 50 are horizontally movable between a resting position within lateral areas 10 of machine 1, and one or more working positions in the central area 11 of machine 1. The geometry of machine 1 can be clearly seen observing FIGS. 1, 2 and 4, in which the two lateral areas 10 can be recognized, where driving motors 44, 32 for the various movable members are also accommodated, as well as the central area 11, in which the stretching and folding operation object of the present invention takes place.

In the resting position, the stretching pushers 4 as well as the supporting and folding assemblies 50 are substantially accommodated in the lateral areas 10, while they are movable in the central area 11 when working, as will be made clearer below.

A lower conveyor belt 15 allows the folded kneading 2 to be conveyed towards a joining station 16 of folded kneadings 2 (FIGS. 12-14).

The novel folding process takes place as follows.

The edible kneading, after about 8 hours of fermentation and with a weight/volume ratio of 0.4-0.5 kg/l, is poured into hopper 3 in the loading position in FIG. 1. Hopper 3 then translates along guide 7 up to the unloading position above the supporting and stretching assemblies 50, which in the meantime have moved into the configuration of maximum travel in the central area 11 from their accommodation in the lateral areas 10 of machine 1, as can be seen in FIG. 7 where the swinging elements 8 are in an open position. Once the kneading 2 has been unloaded, it is thus supported by belts 5, the ends 51 of which are adjacent without touching one another.

Pushers 4 (FIG. 8) begin to stretch the kneading 2, which first is in the form of a compact block (FIG. 7). Having reached satisfactory stretching signalled by suitable sensors (not shown), the assemblies 50 with belts 5 partially retract (FIG. 10), thus widening the space between the ends 51 thereof, so that a central portion 21 of the stretched kneading 2 can fall by force of gravity onto the conveyor belt 15. In this step, pushers 4 are sealed above the lateral portions 22 of kneading 2.

Subsequently, FIG. 11, pushers 4 release the ends 22 of kneading 2 which, upon the approach of the assemblies 50 with belts 5, fold onto the central portion 21 of kneading 2 already supported on belt 5. Subsequent passages of the assemblies 50 with belts 5 above the kneading 2 promote the flattening of the folded kneading 2.

When kneading 2 falls onto belt 15, it partially overlaps a kneading 2 previously folded according to a shape which is clearly shown in FIG. 12. Further pushers or rollers 30, in the joining station 16, contribute to flattening the overlapping portions 23 in order to form a single ribbon of edible kneading subject to subsequent lamination or calibration for further improving the leavening.

At the end of the folding process, the specific weight of the edible kneading is about 0.6 kg/l, higher than the initial 0.4-0.5 kg/l but definitely lower than the 0.8-0.9 kg/l at the end of an extrusion procedure.

The folding machine 1 according to the present invention thus allows the leavening of the kneading to be considerably improved and can be inserted in a common industrial bread-making line, limiting fermenting/leavening times.

1.-8. (canceled)

9. A machine for folding an edible kneading, the machine comprising:
a hopper for loading and unloading an edible kneading, stretching means and a couple of supporting and folding means of the edible kneading, the support and folding means being selectably movable horizontally between opposite lateral resting areas and a central working area of the machine.

10. The machine according to claim 9, wherein in the central area the supporting and folding means are adapted to assume a first working position of maximum travel from the lateral rest areas wherein the extremities of the supporting and folding means are adjacent without touching one another to allow the optimal supporting of the kneading still in the form of a compact block, a second working position of partial travel from the lateral rest areas in such a way that a central position of the kneading by now stretched by the stretching means falls by gravity on a lower support, and a third position again of maximum travel from the lateral resting areas to consent the bending of the lateral portions on the central portion of the kneading.

11. The machine according to claim 10, wherein the supporting and folding means comprise two belts kept in tension by two belt tensioner rollers.

12. The machine according to claim 9, further comprising a couple of stretching pushers, each comprising a contact element with the kneading in substantially horizontal laying supported by a piston vertically sliding inside a box integer with an arm horizontally movable by means of a driving motor.

13. The machine according to claim 12, wherein the contact element provides an inferior not flat surface with two portions inclined towards the bottom which meet in correspondence with a vertical median plane.

14. The machine according to claim 9, further comprising a lower conveyor belt adapted to convey the folded kneading towards a joining station of folded kneading.

15. An automatic baking process of an edible kneading, the process comprising: fermenting/leavening, forming and baking of the kneading and further comprising the step of folding the fermented edible kneading.

16. The process according to claim 15, wherein the folding includes partially opening of a first horizontal supporting plane of the kneading with a consequent falling of a central portion of the kneading on a second horizontal support plane below while lateral portions of the kneading stay tight on the first plane, the folding and supporting of the lateral portions on the central portion following an at least partial closure of the first horizontal support plane.
